(19) United States
(12) Patent Application Publication
(10) Pub. No.: US 2012/0154362 A1
(43) Pub. Date: Jun. 21, 2012

(54) PROJECTION SYSTEM AND PROJECTION APPARATUS

(75) Inventor: Chin-Ku Liu, Hsin-Chu (TW)

(73) Assignee: CORETRONIC CORPORATION, Hsin-Chu (TW)

(21) Appl. No.: 13/225,472

(22) Filed: Sep. 4, 2011

(30) Foreign Application Priority Data
Dec. 15, 2010 (CN) 201010597783.8

(51) Int. Cl. G09G 5/00

(52) U.S. Cl. 345/211

(57) ABSTRACT

A projection system including an electronic device and a projection apparatus is provided. The electronic device has a first power connector and a signal transmission portion. The projection apparatus includes a main body, a second and a third power connector, and a signal receiving portion. The main body is coupled to an external power source through a power cable. The second power connector is disposed on the main body and is coupled to the first power connector. The third power connector is disposed on the main body and is coupled between the second power connector and the power cable. The external power source provides power to the electronic device through the power cable and the third, second, and first power connectors in sequence. The signal receiving portion is disposed on the main body. The electronic device transmits a projection signal to the signal receiving portion through the signal transmission portion.

### CROSS-REFERENCE TO RELATED APPLICATION

This application claims the priority benefit of China application serial no. 201010597783.8, filed on Dec. 15, 2010. The entirety of the above-mentioned patent application is hereby incorporated by reference herein and made a part of this specification.

### BACKGROUND OF THE INVENTION

1. Field of the Invention

The invention relates generally to a projection system and a projection apparatus, and more particularly a projection system including an electronic device and a projection apparatus thereof.

2. Description of Related Art

A projector is a display apparatus which may be adapted for generating a large-sized image. According to an imaging principle of projectors, a beam generated by the light source module is converted into an image beam via a light valve. Afterwards, the image beam passes through the lens and is projected onto a screen or a wall to form an image. With recent advancement in projection techniques and reduction in manufacturing cost of projectors, projector applications have gradually expanded from commercial use to household use.

A user can operate the projector connected to an electronic device. The projector projects the image from the electronic device onto the screen or wall. Typically speaking, the projector receives an external power from a power cable, and the electronic device also receives an external power from another power cable. However, too many cables burden the user in portability and during set up.

U.S. Pat. No. 6,883,918 disclosed a portable projector electrically connected to devices such as a computer or a television through a connector on the projector. Taiwan Patent No. M364979 disclosed a connector having a projection function, adapted for electrically connecting to a circuit board of an electronic device, and the projection connector includes a projection module and an electrical connector. U.S. Application Publication No. 2007/0229780 disclosed a projection apparatus adapted for electrically connecting to an Universal Series Bus (USB) connector socket of a computer, so that the projection apparatus receives power from the computer through an USB transmission cable. Taiwan Patent No. M553439 disclosed a connector block apparatus capable of being plugged into and extracted from a predetermined space of an electronic device.

### SUMMARY OF THE INVENTION

Accordingly, the invention is directed to a projection system and a projection apparatus which are easy to set up.

Other objects and advantages of the invention can be further illustrated by the technical features broadly embodied and described as follows.

In order to achieve one or a portion of or all of the objects or other objects, an embodiment of the invention provides a projection system including an electronic device and a projection apparatus. The electronic device has a first power connector and a signal transmission portion. The projection apparatus includes a main body, a second power connector, a third power connector, and a signal receiving portion. The main body is coupled to an external power source through a power cable. The second power connector is disposed on the main body and coupled to the first power connector. The third power connector is disposed on the main body and is coupled between the second power connector and the power cable. The external power source provides power to the electronic device through the power cable, the third power connector, the second power connector, and the first power connector in sequence. The signal receiving portion is disposed on the main body. The electronic device transmits a projection signal to the signal receiving portion through the signal transmission portion.

In order to achieve one or a portion of or all of the objects or other objects, an embodiment of the invention provides a projection apparatus adapted for a projection system. The projection system includes an electronic device having a first power connector and a signal transmission portion. The projection apparatus includes a main body, a second power connector, a third power connector, and a signal receiving portion. The main body is coupled to an external power source through a power cable. The second power connector is disposed on the main body and coupled to the first power connector. The third power connector is disposed on the main body and is coupled between the second power connector and the power cable. The external power source provides power to the electronic device through the power cable, the third power connector, the second power connector, and the first power connector in sequence. The signal receiving portion is disposed on the main body. The electronic device transmits a projection signal to the signal receiving portion through the signal transmission portion.

In summary, according to embodiments of the invention, the first power connector of the electronic device is coupled to the second power connector of the projection apparatus, and the third power connector of the projection apparatus connects to the external power source through the power cable. Accordingly, the projection apparatus may receive power from the external power source through the power cable and transmit power to the electronic device. Therefore, the electronic apparatus does not require another power cable to connect to the external power source, and thus the projection system is easy to set up.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection system according to an embodiment of the invention.

FIG. 2 is a schematic view of a projection system according to another embodiment of the invention.

FIG. 3 is a schematic view of a projection system according to another embodiment of the invention.

FIG. 4 is a schematic view of a projection system according to another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

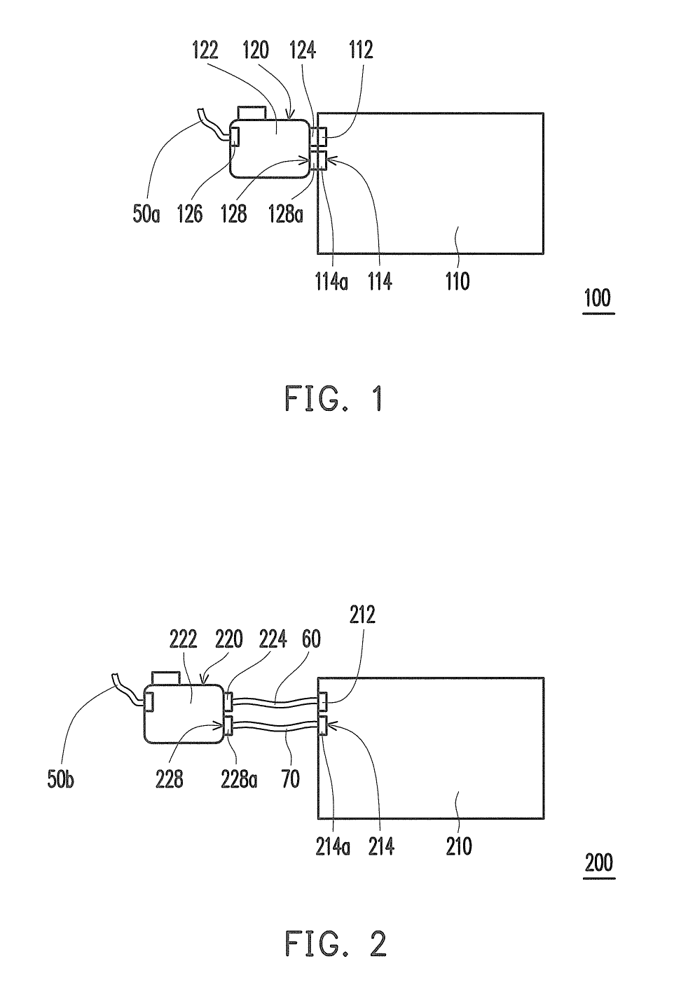

Referring to FIG. 1, a projection system 100 according to the embodiment includes an electronic device 110 and a projection apparatus 120. The electronic device 110 has a first power connector 112 and a signal transmission portion 114. The projection apparatus 120 includes a main body 122, a second power connector 124, a third power connector 126, and a signal receiving portion 128. The second power connector 124, the third power connector 126, and the signal receiving portion 128 are disposed on the main body 122.

In the embodiment, the electronic device 110 may be a portable computer (e.g., notebook computer, tablet computer), a desktop computer (e.g. personal computer), a mobile communication device (e.g. mobile phone), a multimedia player (e.g., electronic frame, portable media player (PMP), Moving Pictures Experts Group-4 (MP4) player), or any electronic device capable of being coupled to an external power source and outputting a video stream, although the invention is not limited by the afore-described devices.

In the embodiment, the second power connector 124 of the projection apparatus 120 is coupled to the first power connector 112 of the electronic device 110, and the third power connector 126 of the projection apparatus 120 is coupled between the second power connector 124 and a power cable 50a. The power cable 50a is adapted for coupling to an external power source, so the external power source provides power to the projection apparatus 120 through the power cable 50a. Accordingly, the external power source provides power to the electronic device 110 through the power cable 50a and the projection apparatus 120. In other words, the external power source provides power to the electronic device 110 through the power cable 50a, the third power connector 126, the second power connector 124, and the first power connector 112 in sequence. The electronic device 110 transmits a projection signal to the signal receiving portion 128 of the projection apparatus 120 through the signal transmission portion 114, so that the projection apparatus 120 projects using the projection signal.

With such a configuration, besides the projection apparatus 120 receiving power from the external power source through the power cable 50a, power can be concurrently transmitted to the electronic device 110. Therefore, the electronic device 110 does not require another power cable to connect to the external power source, and thus the projection system 100 is easy to set up. In the embodiment, the power cable 50a is a standard power cable equipped by the electronic device 110 itself. Moreover, the third power connector 126 of the projection apparatus 120 is designed to be connectable to the power cable 50a in accordance to the specification of the electronic device 110, so that the electronic device 110 and the projection apparatus 120 both use the power cable 50a.

Specifically, in the embodiment, the first power connector 112 of the electronic device 110 is directly plugged into the second power connector 124 of the projection apparatus 120. Moreover, the signal transmission portion 114 of the electronic device 110 includes a first signal connector 114a, the signal receiving portion 128 of the projection apparatus 120 includes a second signal connector 128a, and the first signal connector 114a is directly plugged into the second signal connector 128a. By adopting the afore-described direct plugging connection method, a cable is not required to connect the first power connector 112 and the second power connector 124. Moreover, a cable is not required to connect the first signal connector 114a and the second signal connector 128a, thereby further saving the use of cables, enhancing the ease of setting up the projection system 100, and increasing the convenience in user portability.

Furthermore, in the embodiment, the first power connector 112 and the first signal connector 114a are disposed on a same side of the electronic device 110 (e.g., left side of the electronic device 110 in FIG. 1), and the second power connector 124 and the second signal connector 128a are disposed on a same side of the main body 122 (e.g., right side of the main body 122 in FIG. 1). Moreover, a distance between the first power connector 112 and the first signal connector 114a is equal to a distance between the second power connector 124 and the second signal connector 128a, so that the first power connector 112 and the first signal connector 114a are respectively plugged into the second power connector 124 and the second signal connector 128a directly.

The first signal connector 114a of the embodiment may be a Video Graphics Array (VGA) connector, a High Definition Multimedia Interface (HDMI) connector, a mini port connector, or other suitable types of connectors. Correspondingly, the second signal connector 128a may be a VGA connector, a HDMI connector, a mini port connector, or other suitable types of connectors.

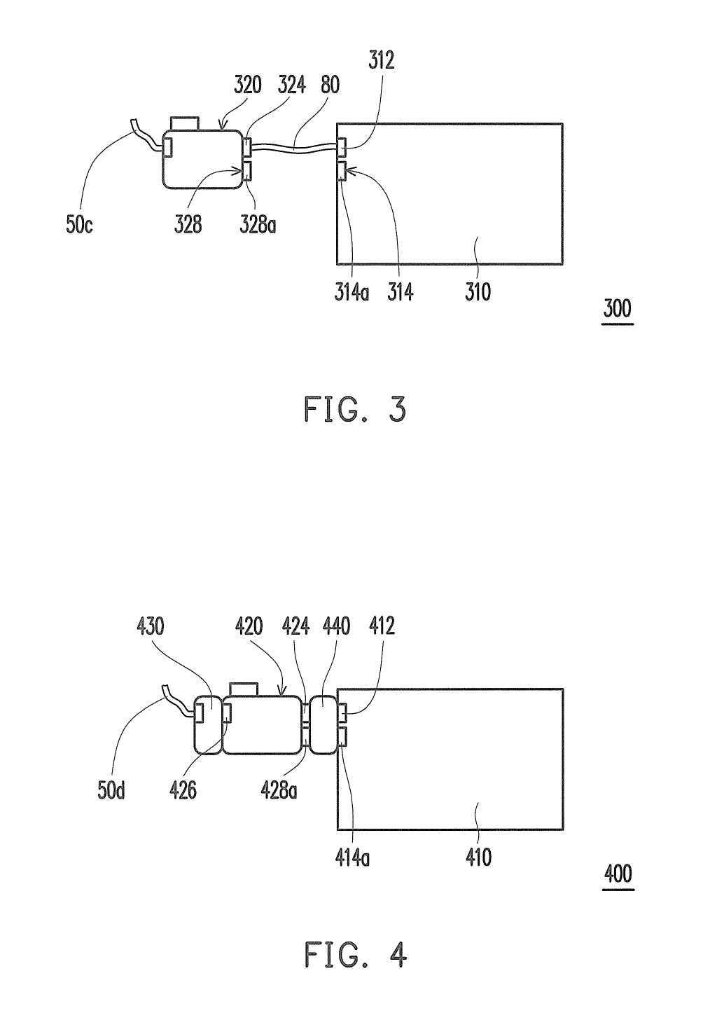

The invention does not limit the connection method of the first power connector 112 and the second power connector 124. For example, besides the direct plugging connection method of the first power connector 112 and the second power connector 124 illustrated in FIG. 1, the connection may be made with a cable. Moreover, the invention does not limit the connection method of the first signal connector 114a and the second signal connector 128a. For example, besides the direct plugging connection method of the first signal connector 114a and the second signal connector 128a illustrated in FIG. 1, the connection may be made with a cable or wirelessly. In the following, an example will be further described with reference to FIGS. 2 and 3.

Referring to FIG. 2, in a projection system 200 according to the embodiment, a first power connector 212 of an electronic device 210 is connected to a second power connector 224 of a projection apparatus 220 through a cable 60. Accordingly, the external power source provides power to the projection apparatus 220 through a power cable 50b, and provide power to the electronic device 210 through the power cable 50b, the projection apparatus 220, and the cable 60. Moreover, a first signal connector 214a of a signal transmission portion 214 of the electronic device 210 connects to a second signal connector 228a of a signal receiving portion 228 of the projection apparatus 220 through a cable 70, so that the electronic device 210 transmits a projection signal to the second signal connector 228a of the projection apparatus 220 through the first signal connector 214a and the cable 70, and the projection apparatus 220 projects using the projection signal.

Specifically, in the embodiment, the cable 60 is designed to be connected to the second power connector 224 and to coil inside a main body 222 of the projection apparatus 220, so that the cable 60 is able to be stored inside the projection apparatus 220 for ease of portability, and so the cable 60 is able to be pulled out from the main body 222 to connect to the first power connector 212, as shown in FIG. 2. Moreover, in the embodiment, the cable 70 is designed to be connected to the second signal connector 228a and to coil inside the main body 222, so that the cable 70 is able to be stored inside the projection apparatus 220 for ease of portability, and so the cable 70 is able to be pulled out from the main body 222 to connect to the first signal connector 214a, as shown in FIG. 2.

Referring to FIG. 3, in a projection system 300 according to the embodiment, a first power connector 312 of an electronic device 310 is connected to a second power connector 324 of a projection apparatus 320 through a cable 80, so that the external power source provides power to the projection apparatus 320 through a power cable 50c, and the external power source provides power to the electronic device 310 through the power cable 50c, the projection apparatus 320, and the cable 80. Moreover, a signal transmission portion 314 of the electronic device 310 includes a wireless emitter 314a. A signal receiving portion 328 of the projection apparatus 320 includes a wireless receiver 328a, and the electronic device 310 transmits a wireless signal to the wireless receiver 328a of the projection apparatus 320, so that the projection apparatus 320 projects using the wireless signal.

Referring to FIG. 4, in the embodiment, besides an electronic device 410 and a projection apparatus 420, a projection system 400 also includes an adapter 430 and an adapter 440. When the specification of a third power connector 426 of the projection apparatus 420 is not compatible with the specification of a power cable 50d, the power cable 50d cannot be directly plugged into the third power connector 426. The power cable 50d is connected to the third power connector 426 through the adapter 430. Moreover, when the specification of a second power connector 424 of the projection apparatus 420 is not compatible with the specification of a first power connector 412 of the electronic device 410, the second power connector 424 cannot be directly plugged into the first power connector 412. The second power connector 424 is connected to the first power connector 412 through the adapter 440, so that the external power source provides power to the projection apparatus 420 through the power cable 50d and the adapter 430, and the external power source provides power to the electronic device 410 through the power cable 50d, the adapter 430, the projection apparatus 420, and the adapter 440.

Furthermore, when the specification of a second signal connector 428a of the projection apparatus 420 is not compatible with the specification of a first signal connector 414a of the electronic device 410, the second signal connector 428a cannot be directly plugged into the first signal connector 414a. The second signal connector 428a is connected to the first signal connector 414a through the adapter 440, so that the electronic device 410 transmits a projection signal to the second signal connector 428a of the projection apparatus 420 through the first signal connector 414a and the adapter 440, and the projection apparatus 420 projects using the projection signal.

In view of the foregoing, according to embodiments of the invention, the first power connector of the electronic device is coupled to the second power connector of the projection apparatus, and the third power connector of the projection apparatus is coupled between the second power connector and the power cable. Accordingly, the projection apparatus receives power from the external power source through the power cable connection and transmits power to the electronic device. Therefore, the electronic device does not require another power cable to connect to the external power source, and thus the projection system is easy to set up.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A projection system, comprising:
an electronic device having a first power connector and a signal transmission portion; and
a projection apparatus, comprising:
a main body adapted to be coupled to an external power source through a power cable;
a second power connector disposed on the main body and coupled to the first power connector;
a third power connector disposed on the main body and coupled between the second power connector and the power cable, wherein the external power source provides a power to the electronic device through the power cable, the third power connector, the second power connector, and the first power connector in sequence; and
a signal receiving portion disposed on the main body, wherein the electronic device transmits a projection signal to the signal receiving portion through the signal transmission portion.

2. The projection system as claimed in claim 1, wherein the first power connector is directly plugged into the second power connector.

3. The projection system as claimed in claim 1, wherein the first power connector is connected to the second power connector through a cable.

4. The projection system as claimed in claim 3, wherein the cable connects to the second power connector and coils inside the main body, and the cable is pulled out from the main body to connect to the first power connector.

5. The projection system as claimed in claim 1, wherein the signal transmission portion comprises a first signal connector, the signal receiving portion comprises a second signal connector, and the first signal connector directly plugs into the second signal connector.

6. The projection system as claimed in claim 1, wherein the signal transmission portion comprises a first signal connector, the signal receiving portion comprises a second signal connector, and the first signal connector connects to the second signal connector through a cable.

7. The projection system as claimed in claim 6, wherein the cable connects to the second signal connector and coils inside the main body, and the cable is pulled out from the main body to connect to the first signal connector.

8. The projection system as claimed in claim 1, wherein the signal transmission portion comprises a wireless emitter, the signal receiving portion comprises a wireless receiver, and the electronic device transmits a wireless signal through the wireless emitter to the wireless receiver.

9. The projection system as claimed in claim 1, wherein the signal transmission portion comprises a first signal connector, the signal receiving portion comprises a second signal connector, the first power connector and the first signal connector disposed on a same side of the electronic device, and the second power connector and the second signal connector disposed on a same side of the main body, and a distance between the first power connector and the first signal connector being equal to a distance between the second power connector and the second signal connector, so that the first power connector and the first signal connector are respectively plugged into the second power connector and the second signal connector directly.

10. The projection system as claimed in claim 1, further comprising an adapter, wherein the power cable connects to the third power connector through the adapter.

11. The projection system as claimed in claim 1, further comprising an adapter, wherein the second power connector and the signal receiving portion are respectively connected to the first power connector and the signal transmission portion through the adapter.

12. The projection system as claimed in claim 1, wherein the electronic device comprises a portable computer.

13. A projection apparatus adapted for a projection system, wherein the projection system comprises an electronic device having a first power connector and a signal transmission portion, the projection apparatus comprising:
a main body adapted to be coupled to an external power source through a power cable;
a second power connector disposed on the main body and coupled to the first power connector;
a third power connector disposed on the main body and coupled between the second power connector and the power cable, wherein the external power source provides power to the electronic device through the power cable, the third power connector, the second power connector, and the first power connector in sequence; and
a signal receiving portion disposed on the main body, wherein the electronic device transmits a projection signal to the signal receiving portion through the signal transmission portion.

14. The projection apparatus as claimed in claim 13, wherein the first power connector is directly plugged into the second power connector.

15. The projection apparatus as claimed in claim 13, wherein the first power connector is connected to the second power connector through a cable.

16. The projection apparatus as claimed in claim 15, wherein the cable connects to the second power connector and coils inside the main body, and the cable is pulled out from the main body to connect to the first power connector.

17. The projection apparatus as claimed in claim 13, wherein the signal transmission portion comprises a first signal connector, the signal receiving portion comprises a second signal connector, and the first signal connector directly plugs into the second signal connector.

18. The projection apparatus as claimed in claim 13, wherein the signal transmission portion comprises a first signal connector, the signal receiving portion comprises a second signal connector, and the first signal connector connects to the second signal connector through a cable.

19. The projection apparatus as claimed in claim 18, wherein the cable connects to the second signal connector and coils inside the main body, and the cable is pulled out from the main body to connect to the first signal connector.

20. The projection apparatus as claimed in claim 13, wherein the signal transmission portion comprises a wireless emitter, the signal receiving portion comprises a wireless receiver, and the electronic device transmits a wireless signal through the wireless emitter to the wireless receiver.

21. The projection apparatus as claimed in claim 13, wherein the signal transmission portion comprises a first signal connector, the signal receiving portion comprises a second signal connector, and the first power connector and the first signal connector disposed on a same side of the electronic device, and the second power connector and the second signal connector disposed on a same side of the main body, and a distance between the first power connector and the first signal connector being equal to a distance between the second power connector and the second signal connector, so that the first power connector and the first signal connector are respectively plugged into the second power connector and the second signal connector directly.

22. The projection apparatus as claimed in claim 13, further comprising an adapter, wherein the power cable connects to the third power connector through the adapter.

23. The projection apparatus as claimed in claim 13, further comprising an adapter, wherein the second power connector and the signal receiving portion are respectively connected to the first power connector and the signal transmission portion through the adapter.
